(19) United States
(12) Patent Application Publication
(10) Pub. No.: US 2008/0005144 A1
(43) Pub. Date: Jan. 3, 2008

(54) Apparatus and method for transferring data between incompatible computer systems

(75) Inventors: Ari Katz, Tel-Aviv (IL); Daniel Mazor, Ottawa (CA); Ariel Laub, Tel-Aviv (IL)

Correspondence Address: Martin D. Moynihan;PRTSI, Inc., P.O. Box 16446, Arlington, VA, 22215, US

(73) Assignee: SeaPass Solutions Inc., New York, NY (US)

(21) Appl. No.: 11/802,367

(22) Filed: May 22, 2007

Related U.S. Application Data
(60) Provisional application No. 60/802,520, filed on May 23, 2006.

(51) Int. Cl. G06F 17/00

(52) U.S. Cl. 707/101; 707/E17.006

(57) ABSTRACT

A bridging platform bridges between one or more source computer systems, each having respective source data formats and one or more target computer systems. The platform includes a print file input for receiving data input as a form at the source system as a print file comprising layout information for printing. An indexing unit indexes between data within the layout information and a unified index, and recognizes the source format of the currently received data to select the correct index. A mapping unit maps data in the data form layout between the unified index and the target data format to place the data into a form usable by the target system. There is additionally provided a method of providing data to a first computer system which was input to a second computer system via a data form. The data form is not itself compatible with the first computer system. In the method a virtual print file is obtained of the data form. The print file is created at the second system and sent to the first systems which then maps data from locations identified in the virtual print file to corresponding locations in a data form of the first computer system.

### RELATIONSHIP TO EXISTING APPLICATIONS

This Application claims the benefit of U.S. Provisional Patent Application No. 60/802,520 on filed May 23, 2006, the contents of which are hereby incorporated by reference.

### FIELD AND BACKGROUND OF THE INVENTION

The present invention relates to apparatus and methods for building compatibility between different computer systems and, more particularly, but not exclusively to methods of data export and import between such incompatible systems.

There are many circumstances in which data collected in one computer system is required for use in another system. One such circumstance is where an organization upgrades to a new system or new formats. Another circumstance is where different organizations need to rely on the same data.

The former circumstance is dealt with by the field of data migration, where automatic methods are used to transfer the data from the old to the new system so as to minimize the need for expensive manual intervention. The latter circumstance is very common in the business world as few organizations are stand-alone in terms of their data processing.

An example of a field in which organizations need to share data is in the business relationship between the retailer and the supplier. A single supplier has to deal with many retailers, and each retailer may deal with multiple suppliers. A retailer who only deals with a single supplier may adopt his supplier's computer system, but this is not an option for most retailers. Orders need to be passed from the retailer to the supplier and inventory etc. needs then to return to the retailer. The data flow needs to include arrangements for payment.

A special case of the retailer-supplier relationship is the insurance industry. Insurance agents deal directly with customers and seek the best possible deals for their own customers from a range of insurance suppliers with whom they deal.

Generally in insurance there is a high degree of customization. No two customers are identical and even two apparently identical customers who ask for the same product are likely to get a different quote depending on personal details which they are required to provide. Thus the insurance agent is not even so much as able to provide a price quote until a considerable quantity of data has been submitted to the supplier. In order to obtain a choice of quotes for his customer he needs to submit substantially the same information to several different suppliers. However each supplier has his own data form. So generally the agent fills in what data he can using his own form and then faxes or posts his form to the supplier. The process is slow.

In the following, an organization that provides services to insurance agencies and brokerages, for example the insurance supplier, is called a trading partner. A computer system that hosts information to be extracted is referred to as a source system. Normally, a source system is an insurance Agency Management System, where information about insured clients and their policies is stored. A trading partner's computer system where the information is to be transmitted is called a target system. A target system can be any of:

an insurance carrier's agent-facing application that enables the agent to enter and perform insurance transactions, e.g. getting quotes and policy issuance;

a comparative rater's application that analyzes policy data and produces a comparison of available rates from multiple insurance companies; and

any other application consuming information that is stored in the source system.

The relationship between the source system and the target system is shown in FIG. 1, where source system 10 is connected to target system 12.

More particularly, the insurance industry suffers from inefficiency due to the inability to seamlessly share information between the trading partners. Many insurance transactions require transmitting information from the source Agency Management System to the trading partner's target systems. Although, in recent years, XML-based and other, data import mechanisms have been introduced by many insurance systems, usability of these features depends on the sending Systems' ability to export data, and many existing Agency Management Systems do not in fact support data export. Often mechanisms are provided but the vendors of the Agency Management Systems do not enable the usage of the provided mechanisms to export data to the applications of their competitors.

Referring now to FIG. 3, an agent fills in information using his own computer system, form 20. However, to transmit information to a trading partner, agents find themselves having to print the relevant information forms from Agency Management Systems and fax or mail them to the insurance company, where the information is then manually re-keyed. Thus the agent goes to printing dialog 22 and prints out form 24 for posting. At the supplier end the form is used to key in data to the supplier's computer system and transaction results (for instance, an insurance quote) are printed and faxed or mailed back to the agent.

This process leads to a number of problems, as further illustrated in FIG. 3, where the arrow connecting the two systems in FIG. 1 is shown to be a manual link. Problems with the manual link include the following:
1. Transaction costs are high.
2. There is a relatively high probability of errors and omissions.
3. Customer service is poor due to increased length of turnaround.
4. Information security risks are present due to
   Insecure forms of communication: mail and fax.
   Additional personnel is involved in the process and exposed to the personal information of the insured clients.

In order to deal with the above problem U.S. patent application Ser. No. 10/376,505 discloses a system in which data from an incoming system is transformed into a central format and then the central format is used to provide data to the receiving systems in a form that is understood by the receiving systems. The cited system uses sample messages, sample responses and matching in order to determine how to map between the two systems. The cited system however assumes the arrival of data in a manner that is already recognizable to the mapping system. That is to say it knows how to map messages it has already seen. However there is no specific teaching about messages which vary, as in insurance application forms where no two forms are filled in identically.

There is thus a widely recognized need for, and it would be highly advantageous to have, a system for briding devoid of the above limitations.

### SUMMARY OF THE INVENTION

According to one aspect of the present invention there is provided a bridging platform for bridging between one of a plurality of source computer systems, each having respective source data formats and at least one target computer system, said at least one target system comprising a target data format, said platform comprising:

a print file input configured for receiving data as a print file comprising layout information for printing;

an indexing unit configured for indexing between data within said layout information and a unified index, and further configured for recognizing a respective source format of said currently received data and thereby to select indexing modified for said source data format, thereby to arrive at said unified index; and

a mapping unit configured for mapping said data in said data form layout between said unified index and said target data format, said target data format being different from said source data format, thereby to render data provided by a respective source computer system to be usable in said target computer system.

According to a second aspect of the present invention there is provided a bridging method for bridging between one of a plurality of source computer systems, each having respective source data formats and at least one target computer system, said at least one target system comprising a target data format, said method comprising:

receiving data in a respective print file layout defining at least data and locations for said data within a form according to said source data format;

indexing between data in said defined locations and a unified index, said indexing comprising recognizing a respective source format of said currently received data and thereby selecting indexing modified for said source data format, thereby to match data at said locations with said unified index; and

mapping said data in said print file layout between said unified index and said target data format, said target data format being different from said source data format, thereby to render data provided by a respective source computer system to be usable in said target computer system.

According to a third aspect of the present invention there is provided a method of providing data to a first computer system which was input to a second computer system via a data form, said data form not being compatible with said first computer system, the method comprising:

obtaining from said second computer system a virtual print file of said data form;

mapping data from locations identified in said virtual print file to corresponding locations in a data form of said first computer system.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified block diagram showing a source system and a target system;

FIG. 2 is a simplified sequence diagram showing how communication may be carried out manually between the source system and target system of FIG. 1;

FIG. 3 is a simplified block diagram showing the manual leg between the source and target systems according to the prior art;

FIG. 4 is a simplified block diagram showing a source system and a target system connected electronically, according to a preferred embodiment of the present invention;

FIG. 5 is a simplified diagram showing the bridging platform enabling connection between the source and target systems, according to a preferred embodiment of the present invention;

FIG. 6 is a simplified flow chart, showing the operation of the platform of FIG. 5, according to a preferred embodiment of the present invention;

FIG. 7 illustrates a sequence of screens and an output file used by an agent at a source system, in according to a preferred embodiment of the present invention;

FIG. 8 is a simplified diagram showing a virtual print file with an indexing table and showing how indexing is made easier by working with a virtual print file according to a preferred embodiment of the present invention;

FIG. 9 is a simplified block diagram of a configuration of a preferred embodiment of the present invention for use with two different target systems;

FIG. 10 is a simplified block diagram of an alternative configuration for use with two or more target systems, according to a preferred embodiment of the present invention; and

FIG. 11 is a block diagram of a system according to a preferred embodiment of the present invention in which two source systems are present, and illustrating how configurations of the present invention minimize maintenance requirements at the source system.

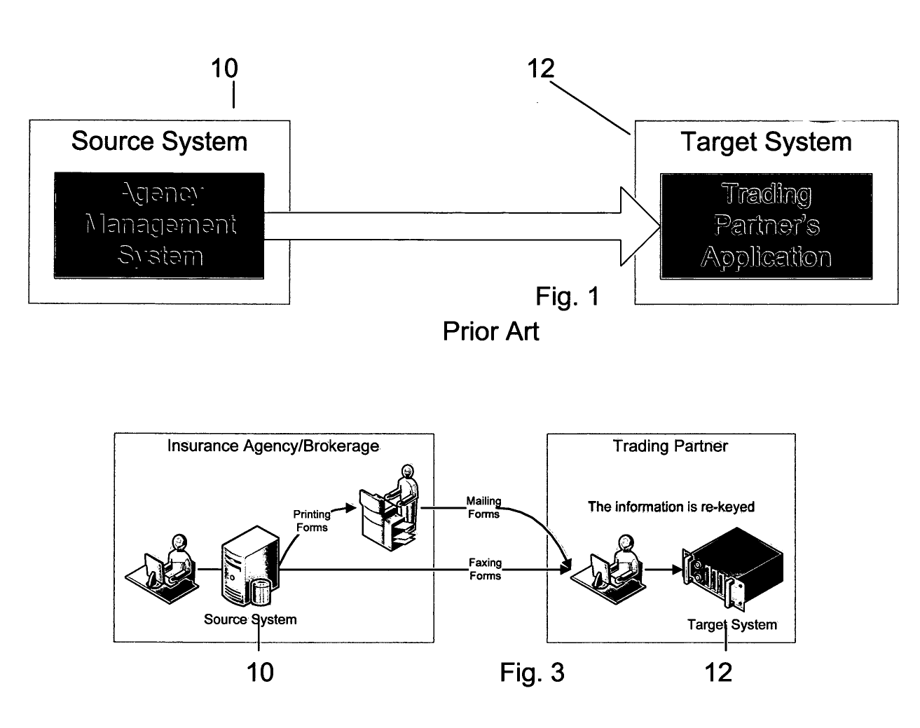

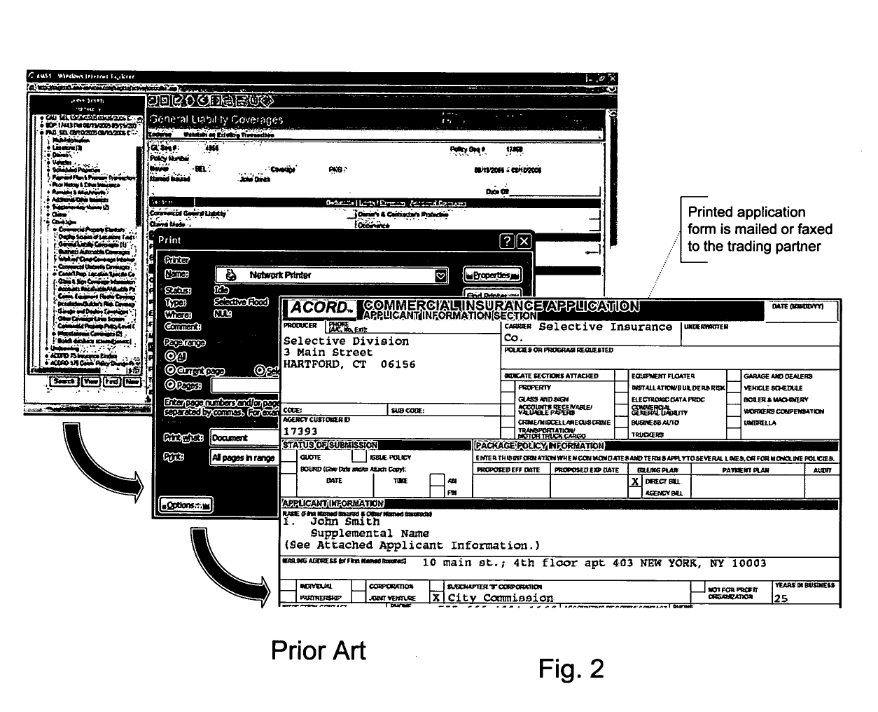

### DESCRIPTION OF THE PREFERRED EMBODIMENTS

The present embodiments comprise an apparatus and a method for bridging between two otherwise incompatible computer systems. The source system in any event sets out the data on a form that is intended for two purposes, firstly display on the screen and secondly for printing. For the purpose of printing, a print file is created from the form.

The present embodiments involve using the display or print format of the form as the basis on which to do indexing. Preferably a virtual printer is used to obtain a specific XML format. Indexing is then carried out to map the input system data from the XML to a central format and from the central format to that of the target system. However now since an XML, or other print or display file is used, the indexing is more effective.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

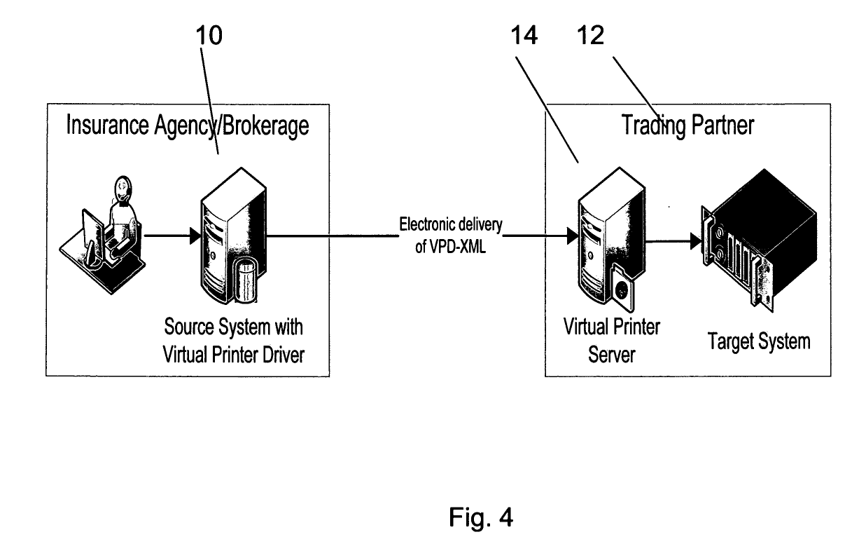

Reference is now made to FIG. 4, which shows a bridging platform 14 which bridges between one of a plurality of source computer systems 10 each having different source data formats and a target computer system 14. The bridging ensures that the data output from the source system is usable in the target system despite their non-compatibility.

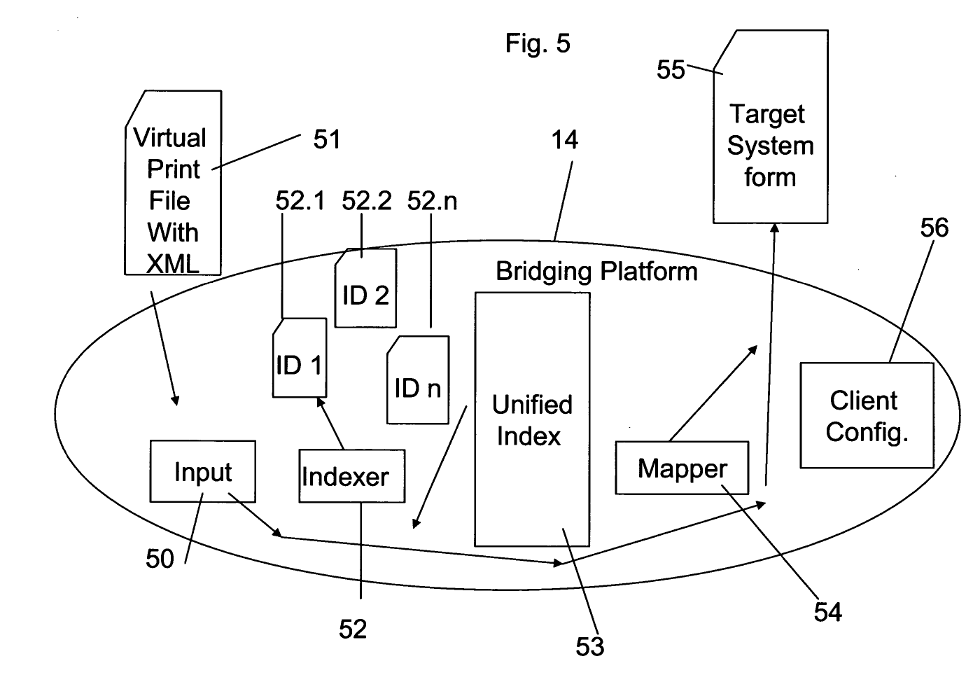

Reference is now made to FIG. 5 which illustrates the bridging platform in greater detail. The bridging platform includes a print file input 50 which receives data in printer input or print file format, that is a format that tells the printer inter alia what characters to print at what location and in what font or style. The print file is typically created from a data entry form on the agent's system. The form itself is compatible with the source system and not with the form layout of the target system. Hence such forms have generally been transferred manually and the data manually keyed in.

More particularly, the source system and the target system are looking for the same information, they trade in the same things, and are therefore bound to ask the same questions, however that does not mean that their forms will automatically be compatible. For example both forms, that of the first system and that of the second system, may want the full name of the customer, but one form may ask for first name, middle name and family name as separate entries and the second form may ask for the same data as a single entry. Furthermore the data entry locations in the two forms may be different. In such a case it is a difficult problem for a machine to take the first form and automatically map to the second form. That is to say it is not straightforward for a machine to pick out the information for correct transfer to the second form.

In the present embodiments the print file input typically accepts print file data that is derived from a web form type interface. However the data is received, not merely as a data set, but rather with data form layout information included. The data form layout is preferably made up directly from the input form at the source, because at the source the individual fields are distinct. Field structures etc. tend to be lost as data is transferred to different systems. That is to say, once the form gets outside its system of origin then exact information is lost. The print file layout preferably includes such information as textual values, font sizes, positions, font types and related values.

In an embodiment the data is marked up at the source system using a virtual printer and a mark up language, typically XML, so that a virtual print file is generated in which each field is clearly located and identified as such. A virtual printer is a modified printer driver which works with the printing system of the local operating system and uses the print command functions to create a file suitable for printing. However the file is not sent to a printer and is tailored for use by the platform of the present embodiments rather than for any specific printer.

Using a virtual printer allows layout information to be strictly retained whilst the form is transferred between systems. In the print file, information is less easily lost, as the locations and contents are reliably recorded, allowing data location to be used as the basis for matching between source and target forms. The above described problem of locating the name from a large number of fields on the form is considerably easier for a machine if the data location is reliably retained.

However, the three names at the three distinct locations mean nothing in themselves to a machine. Thus there is further providing an indexing unit 52 which indexes between data in the data form layouts, that is at the different locations, and a unified index 53. The indexing unit typically recognizes the particular source format of the currently received data, for example via an identifier included in the markup and thus selects an appropriate index table 52.1 . . . 52.n. Hence as long as the particular source has an indexing table, the indexing unit is able to correctly index the data, thereby to arrive at the unified index. The three name fields may for example be indexed as ‘name 1’, ‘name 2’ and ‘name 3’ in the unified index.

If the input data had used a different format, say a single field with all three names together and marked as ‘customer name’, an alternate index table would be selected. The index table would simply look for word units separated by spaces in the name and sequentially assign the word units to the same ‘name 1’, ‘name 2’ and ‘name 3’. That is to say the input format may change, but the central format, the unified index is invariant over the different input sources.

However the data is still not suitable for the target system. The target system does not understand the unified indexing. Therefore mapping unit 54 is provided which uses the unified index to map the data which was received in the data form layout to the target system's form, based on the unified index. The data is now usable in the target computer system.

In an embodiment, the platform includes a client configuration node 56 which provides the source computer system 10 with a virtual printer for modifying the data forms of the source system into the marked up version required. It is noted that no specialist knowledge of the source system is required by the virtual printer so only a standard download is needed to configure the source system to work with the platform. Specialist knowledge of the source system is preferably provided at the platform itself in the shape of the indexing unit 52. The indexing unit may be configured with a separate index table for each source system supported, to allow mapping to the unified index.

The mapping unit may be provided with multiple mapping tables if it is desired to accommodate multiple target computing systems. Each target system uses a different target system format, and the tables provide individual mappings from the unified index to each of the target systems.

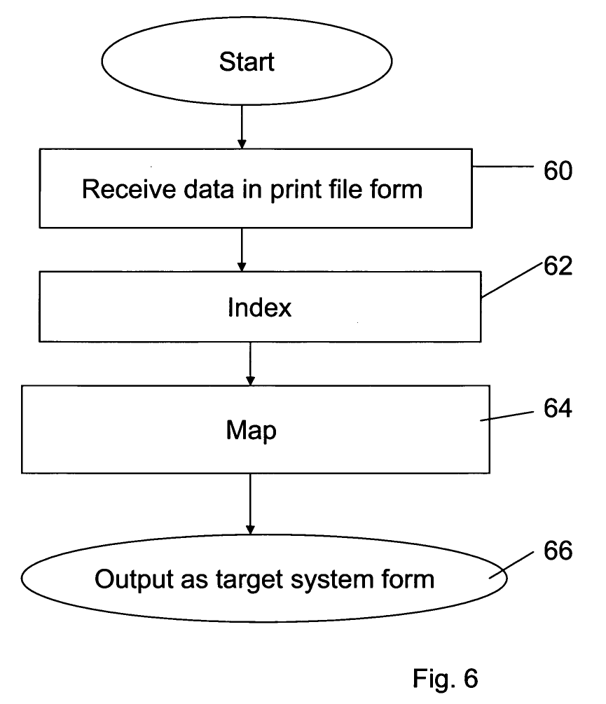

Reference is now made to FIG. 6 which is a simplified flow chart illustrating the procedure involved in using the platform of FIG. 5. The process involves a stage 60 of receiving data in the print file layout . As mentioned the layout includes text values and other parameters which make the form readable to another machine. A stage 62 involves indexing between data in data form layouts and a unified index. The indexing involves recognizing the source format and selecting the appropriate indexing table. The result is the input data indexed to the unified index. Then in a stage 64 the unified indexing is used to map the input data to the target data format.

Agents are preferably provided with a Virtual Printer Driver. The virtual printer drives appears to computer applications, including the source system, as a regular printer, but instead of creating a conventional paper document, the Virtual Printer driver of the present embodiments creates a printer file, or more particularly a VPD-XML file, an XML-based file that electronically represents the information that was to be printed. The XML document is electronically delivered to the virtual printer server 14, where it is parsed and converted into a format that is acceptable by the target system, as explained above.

Virtual printers are conventionally used to capture printable or layout information. The most well-known example of a virtual printer is Adobe PDF-writer. The present embodiments make use of a virtual printer for data extraction, electronic delivery and sharing of information with trading partners, and elimination of re-keying.

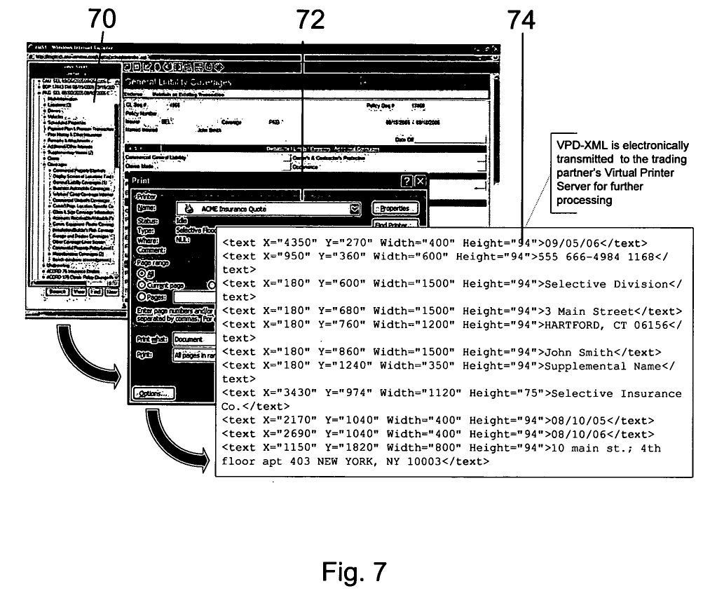

Reference is now shown to FIG. 7 which shows the procedure used by the agent to send his data to the platform. The procedure is shown in terms of the computer screens involved. First of all the agent chooses a printable screen 70 or a set of screens that cover the information to be transmitted to the trading partner, typically his data input form. The user then presses the Print button or chooses “Print” from application method, etc. In the print properties dialog box 72 the user chooses the relevant Virtual Printer Driver, in the example of FIG. 7 the printer “ACME Insurance Quote” is selected.

The Virtual Printer Driver records all printing instructions generated by the printing application into an XML-based file (VPD-XML) 74. Note that file 74 is not necessarily shown on the user's screen. The Virtual Printer Driver then connects to the platform, the trading partner's Virtual Printer Server and transmits the VPD-XML. The Virtual Printer Server platform then uses techniques such as XSLT (Extensible Stylesheet Language Transformations), to convert the incoming XML to the format that the target system expects. As explained in Wikipedia, (XSLT) is an XML-based language used for the transformation of XML documents, and is designed to transform XML documents into other XML documents. The original document is not changed; rather, a new document is created based on the content of an existing one. The new document may be serialized (output) by the processor in standard XML syntax or in another format, such as HTML or plain text, in the present case the format expected by the target system.

The Virtual Printer Server finally forwards the converted file to the target system. Optionally, the target system sends back a response to the Virtual Printer Server.

The response is now sent to the Virtual Printer Driver. The response may include a return code and/or instruction to be performed on the client computer, for instance, to present a message or launch a browser, etc.

VPD-XML Generation

Printer drivers (including the Virtual Printer Driver of the present embodiments) are built as a series of functions that the operating system and the printing application invoke to print a document. In conventional printer drivers these functions generate instructions to the printing hardware.

The Virtual Printer Driver does not generate such instructions, but records the events of invoking these functions and the parameters. The recorded information includes textual values, position, size, font and other information. The recorded information may be used by the Virtual Printer Server to retrieve the relevant data values for the target system. For example, sending a Business Owner's Policy application form to Virtual Printer Driver from a popular Agency Management System generates the VPD-XML shown in Table 1. It is noted that only a small portion of the actual output is shown in the Table.

TABLE 1
Sample Partial Application Form as Virtual Print File

| | | | | | |
|---|---|---|---|---|---|
| <page> | | | | | |
| <text | X=“4530” | Y=“230” | Width=“136” | Height=“59” | Font=“Arial |

Bold”>DATE</text>

| | | | | | |
|---|---|---|---|---|---|
| <text | X=“570” | Y=“390” | Width=“177” | Height=“59” | Font=“Arial |

Bold”>PHONE</text>

| | | | | | |
|---|---|---|---|---|---|
| <text | X=“570” | Y=“390” | Width=“177” | Height=“59” | Font=“Arial |

Bold”>PHONE</text>

| | | | | | |
|---|---|---|---|---|---|
| <text | X=“180” | Y=“404” | Width=“285” | Height=“59” | Font=“Arial |

Bold”>PRODUCER</text>

| | | | | | |
|---|---|---|---|---|---|
| <text | X=“2070” | Y=“404” | Width=“254” | Height=“59” | Font=“Arial |

```
Bold”>COMPANY</text>
        <text X=“4514” Y=“404” Width=“278” Height=“59” Font=“Arial Bold”>NAIC
CODE</text>
        <text X=“570” Y=“436” Width=“337” Height=“59” Font=“Arial Bold”>(A/C, No,
Ext):</text>
        <text X=“570” Y=“436” Width=“337” Height=“59” Font=“Arial Bold”>(A/C, No,
Ext):</text>
```

| | | | | | |
|---|---|---|---|---|---|
| <text | X=“2070” | Y=“604” | Width=“973” | Height=“59” | Font=“Arial |

Bold”>COMPANY POLICY OR PROGRAM NAME</text>

| | | | | | |
|---|---|---|---|---|---|
| <text | X=“3780” | Y=“624” | Width=“434” | Height=“59” | Font=“Arial |

Bold”>PROGRAM CODE:</text>

| | | | | | |
|---|---|---|---|---|---|
| <text | X=“2400” | Y=“904” | Width=“425” | Height=“59” | Font=“Arial |

Bold”>EFFECTIVE DATE</text>

| | | | | | |
|---|---|---|---|---|---|
| <text | X=“2924” | Y=“904” | Width=“453” | Height=“59” | Font=“Arial |

Bold”>EXPIRATION DATE</text>

| | | | | | |
|---|---|---|---|---|---|
| <text | X=“3990” | Y=“906” | Width=“392” | Height=“59” | Font=“Arial |

Bold”>PAYMENT PLAN</text>

| | | | | | |
|---|---|---|---|---|---|
| <text | X=“180” | Y=“1024” | Width=“161” | Height=“59” | Font=“Arial |

```
Bold”>CODE:</text>
        <text X=“1110” Y=“1024” Width=“280” Height=“59” Font=“Arial Bold”>SUB
CODE:</text>
        <text X=“180” Y=“1104” Width=“575” Height=“59” Font=“Arial Bold”>AGENCY
CUSTOMER ID</text>
```

| | | | | | |
|---|---|---|---|---|---|
| <text | X=“4470” | Y=“1104” | Width=“219” | Height=“59” | Font=“Arial |

```
Bold”>DEPOSIT</text>
        <text X=“3150” Y=“1106” Width=“330” Height=“59” Font=“Arial Bold”>POLICY
TYPE</text>
        <text X=“3510” Y=“1406” Width=“228” Height=“59” Font=“Arial Bold”>GL
CODE</text>
        <text X=“3930” Y=“1406” Width=“82” Height=“59” Font=“Arial Bold”>SIC</text>
```

| | | | | | |
|---|---|---|---|---|---|
| <text | X=“4290” | Y=“1406” | Width=“340” | Height=“59” | Font=“Arial |

Bold”>FEDERAL ID #</text>
<text X=“180” Y=“1406” Width=“676” Height=“59” Font=“Arial Bold”>NAME
(First Named Insured)</text>

| | | | | | |
|---|---|---|---|---|---|
| <text | X=“3510” | Y=“1694” | Width=“177” | Height=“59” | Font=“Arial |

Bold”>PHONE</text>

| | | | | | |
|---|---|---|---|---|---|
| <text | X=“2370” | Y=“1706” | Width=“684” | Height=“59” | Font=“Arial |

```
Bold”>CONTACT FOR INSPECTION</text>
        <text X=“180” Y=“1706” Width=“936” Height=“59” Font=“Arial Bold”>MAILING
ADDRESS (INCLUDING ZIP+4)</text>
        <text X=“3510” Y=“1738” Width=“337” Height=“59” Font=“Arial Bold”>(A/C, No,
Ext):</text>
```

The Virtual Printer Driver does not distinguish between actual values (e.g. HARTFORD, Conn. 06156) and the printed form's field titles (e.g. EFFECTIVE DATE) and so both the actual values and the titles appear in the VPD-XML. Later on, the separation may be achieved by the Virtual Printer Server during data translation, as will be explained.

Electronic Delivery

The VPD-XML file is then sent to the Virtual Printer Server, and there it is converted to the format expected by the target system. Any method (both synchronous and asynchronous) of electronic delivery may be used between Virtual Printer Driver and Server, including, but not limited to:
1. Posting VPD-XML over HTTP or invoking a web-service,
2. Using messaging protocols, e.g. MS-MQ or MQ-Series, and
3. Sending VPD-XML as an email attachment.

Mapping and Translation

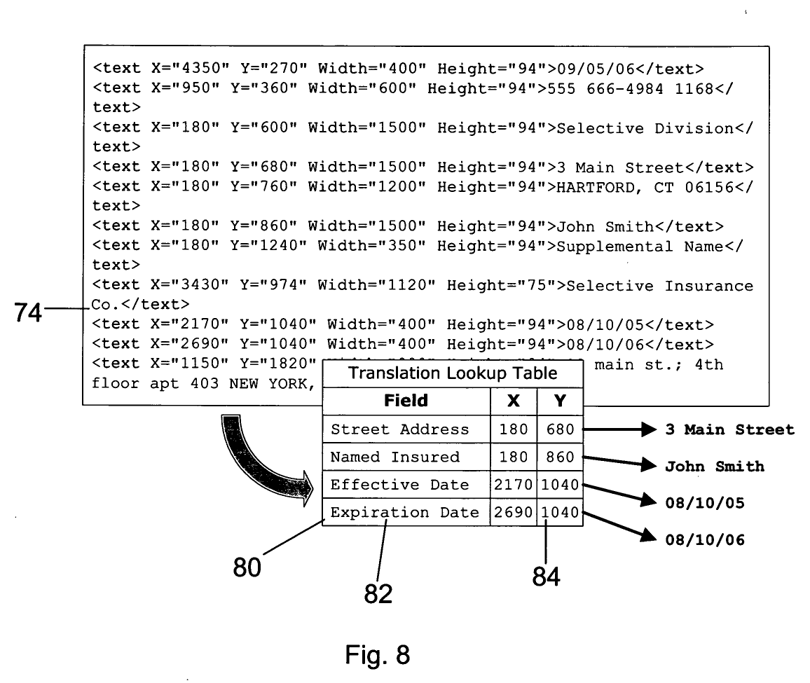

Reference is now made to FIG. 8, which is a simplified diagram showing the virtual print file 74, and an associated index table or translation look up table 80 which links particular features 82 of the unified index with co-ordinates 84, which are taken by the virtual printer from the layout in the agent's original form. The co-ordinates appear explicitly in the virtual print file so that the platform does not have to measure to find the expected information. The co-ordinates are generally received exactly because the virtual printing was carried out on the original software version of the form, and thus identifying the different fields is simply a matter of using the look-up table.

Thus for example, I wish to find the street address from the form. My prior knowledge of the agent's form tells me that the field for the street address has co-ordinates of 180, 680. The virtual print file tells me that at co-ordinates 180, 680 is to be found the text “3 Main Street”. The data “3 Main Street” can thus be labeled as the street address and supplied to the target system in the way that the target system requires the street address.

Using the above process, the VPD-XML is received by the Virtual Printer Server, and is preferably translated into a format that is expected by the target system. The architecture of the Virtual Printer Server does not impose any limitations on the translation methodology so any XML-related technology can be used to parse VPD-XML and convert it to the required format. XSLT, XPath and many other XML-relate tools and technologies are available and can be used to accomplish this.

As just explained, to retrieve a field value, the Virtual Printer Server may use a look-up table, such as table 80, linking the field to its text block position in the VPD-XML files. Other meta-data (e.g. font name, etc.) can be used too.

As a further example, to retrieve the proposed effective date, the Virtual Printer Driver may look for the text block at coordinates 2170:1040 (X=“2170”Y=“1040”), thus:
“<text X=“2170” Y=“1040” Width=“400” Height=“94” Font=“Courier New Bold”>08/10/05</text>”.

The driver knows where to look because the look-up table is customized for the particular source.

The Virtual Printer Server can use several look-up tables, as explained above, and choose the most relevant one according to the type of the source system and the version.

Multiple Target Systems

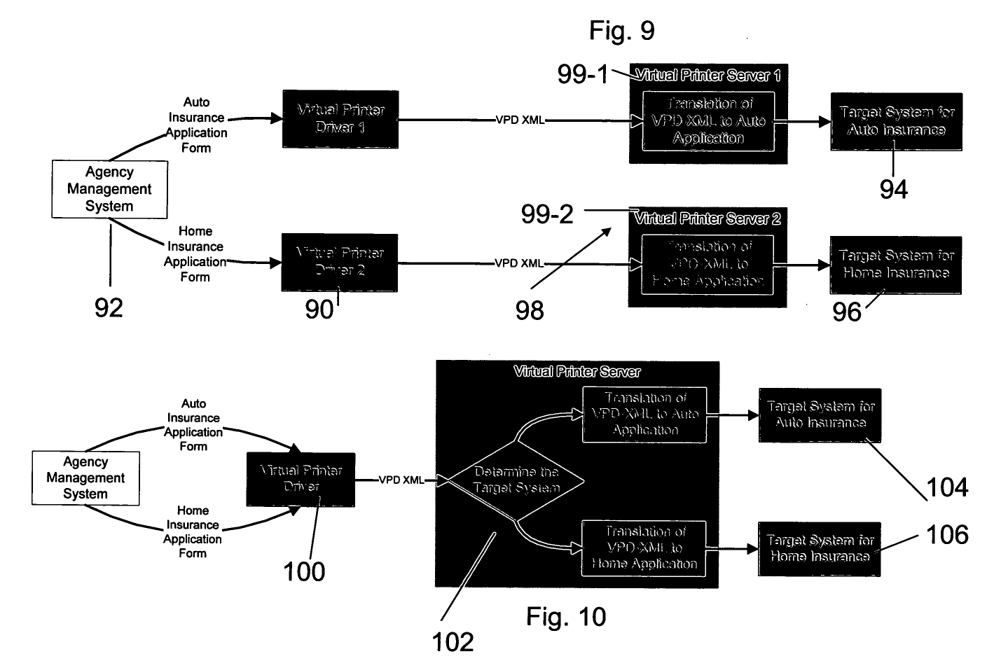

Reference is now made to FIGS. 9 and 10, which are block diagram showing two alternative configurations for a multi-target system. Often a single trading entity or trading partner uses several systems. For instance, separate applications might be used to handle different lines of business. A particular target system may have one subsystem working on life insurance, another subsystem working on car insurance, and yet a third subsystem working on maritime insurance. To enable the Virtual Printer Driver to send data to all of the trading partner's target system, the following approaches can be used:
1. As shown in FIG. 9, multiple instances of a Virtual Printer Driver 90 can be deployed to clients 92; each instance targeting a different system 94 and 96 of the trading partner 98. That is to say each of the target systems 94 and 96 has its own virtual printer server 99-1 and 99-2. This method also works well when the target systems belong to different trading partners.
2. As shown in FIG. 10, a single instance of the Virtual Printer Driver 100 is used for all target systems; and subsequent routing is performed by the Virtual Printer Server 102 after it analyzes the incoming VPD-XML. The printer server is then able to carry out the appropriate translation and pass the information to the relevant target system 104.

Supporting Different Source Systems and Versions

In many cases the individual target systems also need to receive information from different source Agency Management Systems and/or different versions. Since VPD-XML merely represents the printing events, different source systems or versions may well produce different VPD-XML structures that all need to be translated into a single data format that is expected by the target system.

The translation is performed by the Virtual Printer Server as described above. The virtual printer server examines VPD-XML and determines the type of the source system and printed form. The server then chooses the relevant target system and a set of conversions/mappings, performs the conversion of VPD-XML into the format expected by the target system, and uploads the converted information to the target system. As mentioned above a uniform index preferably mediates between the source and target.

Minimizing Client-Side Maintenance

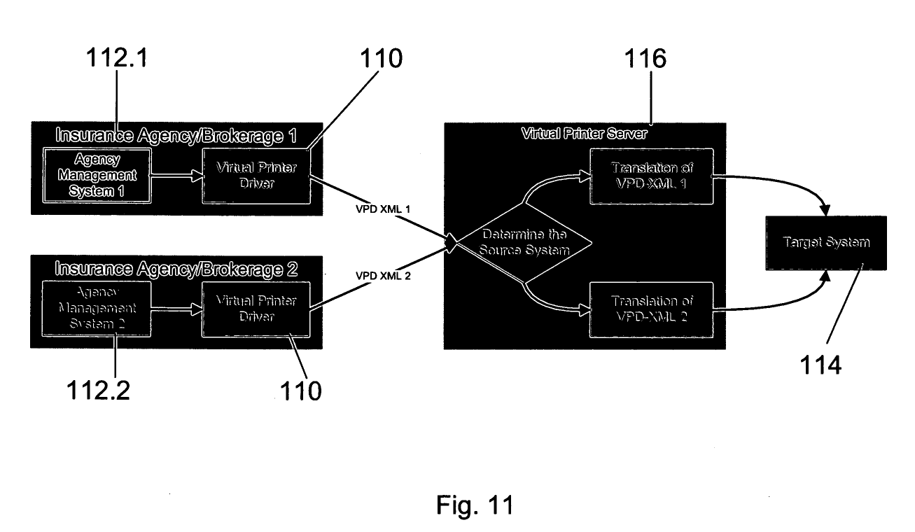

Reference is now made to FIG. 11, which is a simplified diagram illustrating an arrangement in which the virtual printer driver 110 is installed at multiple users 112.1, 112.2. That is to say the present embodiments may involve client-side installation of a virtual Printer Driver. However, to minimize maintenance, the Virtual Printer Driver does not host any logic other than translating printing events into VPD-XML. As a result there is only one version of Virtual Printer Driver per operating system. The version is suitable for all source systems and printable forms, and all target systems that use the same operating system.

As a result, events such as the following do not require upgrading of clients:
Changing information mapping.
Adding support for new printable forms and/or target systems.

The Virtual Printer can be used with any source system that supports printing. There is no need to make any changes to the source systems. From the end-user's standpoint there is no change in his or her work. He simply needs to choose the correct printer when finished so that instead of printing forms and snail-mailing or faxing them for re-keying, virtual printing instantly transmits the data to the target system.

The Virtual Printer can be used with any target system 114 that supports data import. Performing analysis and translations by the Virtual Printer Server 116 simplifies upgrades and reduces maintenance costs. The Virtual Printer can be used to connect source systems to both local (residing in the same data center) and remote target systems. The virtual Printer Server can reside in the same data center where the target system does, or in a hosted environment.

The Virtual Printer not only shortens transaction times and eliminates errors and omissions, but can also increases information security by using an option of encrypted communication between the Virtual Printer Driver and Server.

It is expected that during the life of this patent many relevant devices and systems will be developed and the scope of the terms herein, particularly of the terms virtual printer, and XML, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A bridging platform for bridging between one of a plurality of source computer systems, each having respective source data formats and at least one target computer system, said at least one target system comprising a target data format, said platform comprising:
a print file input configured for receiving data as a print file comprising layout information for printing;
an indexing unit configured for indexing between data within said layout information and a unified index, and further configured for recognizing a respective source format of said currently received data and thereby to select indexing modified for said source data format, thereby to arrive at said unified index;
a mapping unit configured for mapping said data in said data form layout between said unified index and said target data format, said target data format being different from said source data format, thereby to render data provided by a respective source computer system to be usable in said target computer system.

2. The bridging platform of claim 1, wherein said print file input is configured to receive print files wherein said formatting information comprises mark-up language.

3. The bridging platform of claim 1, wherein said print file input is configured such that said print file is a virtual print file produced by a virtual printer.

4. The bridging platform of claim 3, further configured with a client configuration node for providing a source computer system with a virtual printer for modifying data forms of said source system into a marked up version of a data form.

5. The bridging platform of claim 1, wherein said indexing unit is configured for each source system supported, and said configuration comprises providing for each source a respective source index for indexing data items between said respective source system and said unified index.

6. The bridging platform of claim 1, configured for use with a plurality of target computing systems, each using a different target system format, said configuration comprising providing for said mapping unit independent mappings from said unified index to each of said target systems.

7. A bridging method for bridging between one of a plurality of source computer systems, each having respective source data formats and at least one target computer system, said at least one target system comprising a target data format, said method comprising:
receiving data in a respective print file layout defining at least data and locations for said data within a form according to said source data format;
indexing between data in said defined locations and a unified index, said indexing comprising recognizing a respective source format of said currently received data and thereby selecting indexing modified for said source data format, thereby to match data at said locations with said unified index; and
mapping said data in said print file layout between said unified index and said target data format, said target data format being different from said source data format, thereby to render data provided by a respective source computer system to be usable in said target computer system.

8. The bridging method of claim 7, comprising receiving said print file wherein said locations are marked up using mark-up language.

9. The bridging method of claim 7, comprising receiving said print file as a virtual print file.

10. The bridging method of claim 7, further comprising providing a source computer system with a virtual printer for modifying data forms of said source system into a marked up version of a data form.

11. The bridging method of claim 7, comprising providing for each source a respective source index for indexing data items between said respective source system and said unified index.

12. The bridging method of claim 7, for use with a plurality of target computing systems, each using a different target system format, said method comprising providing, for said mapping, independent mappings from said unified index to each of said target systems.

13. A method of providing data to a first computer system which was input to a second computer system via a data form, said data form not being compatible with said first computer system, the method comprising:
obtaining from said second computer system a virtual print file of said data form;
mapping data from locations identified in said virtual print file to corresponding locations in a data form of said first computer system.

14. The method of claim 13, comprising providing an index table of locations in said virtual print file, said index table being selected for said second computer system, and using table entries of said index table to map data from said virtual print file to find data for said mapping.
